(19) United States
(12) Patent Application Publication
(10) Pub. No.: US 2022/0392097 A1
(43) Pub. Date: Dec. 8, 2022

(54) FLUID DENSITY GRADIENT DETECTION METHOD AND FLUID DENSITY GRADIENT DETECTION SYSTEM

(71) Applicant: PANASONIC INTELLECTUAL PROPERTY MANAGEMENT CO., LTD., Osaka (JP)

(72) Inventor: Ikuo FUCHIGAMI, Fukuoka (JP)

(73) Assignee: PANASONIC INTELLECTUAL PROPERTY MANAGEMENT CO., LTD., Osaka (JP)

(21) Appl. No.: 17/825,610

(22) Filed: May 26, 2022

(30) Foreign Application Priority Data
May 31, 2021 (JP) 2021-091788

(51) Int. Cl. G06T 7/62; G01N 9/00; G06T 7/11; G06T 7/80

(52) U.S. Cl. CPC G06T 7/62; G01N 9/00; G06T 7/11; G06T 7/80

(57) ABSTRACT

A fluid density gradient detection method includes capturing, by an imaging device under a predetermined imaging condition, a background image that forms a periodic pattern over an observation target area, and outputting an image indicating a fluid density gradient in the observation target area based on a captured image captured by the imaging device. The imaging condition is determined based on a relationship between a width of a pixel of the captured image in a direction in which the pattern periodically changes on the captured image and a pattern period width of the pattern on the captured image.

### CROSS-REFERENCE TO RELATED APPLICATIONS

This application is based on and claims priority under 35 USC 119 from Japanese Patent Application No. 2021-091788 filed on May 31, 2021, the contents of which are incorporated herein by reference.

### TECHNICAL FIELD

The present disclosure relates to a fluid density gradient detection method and a fluid density gradient detection system that visualize a fluid density gradient.

### BACKGROUND ART

As a method of visualizing a density gradient of an airflow, a Schlieren method is known in which a phenomenon in which passing light is refracted due to the density gradient in a transparent gas is used to observe a change in refractive index as a difference in brightness and darkness.

In order to visualize the density gradient of the airflow by using the Schlieren method, an optical system for creating parallel light and a knife edge for blocking a main light flux are necessary, and there are problems that a technique is required for adjusting an optical axis of the optical system, a place for installation, and an imaging direction is restricted.

As a method of visualizing the density gradient of the airflow that does not require the optical system that generates the parallel light or a light blocking unit, a background oriented schlieren method (hereinafter, referred to as a “BOS method”) is known (for example, see Non-Patent Literature 1). For example, Patent Literature 1 discloses a method of visualizing a density gradient by blocking light by a light blocking unit according to a pattern projected by a projector using the BOS method.

### CITATION LIST

### Patent Literature

Patent Literature 1: Japanese Patent No. 6796306
Patent Literature 2: Japanese Patent No. 5800174

### Non-Patent Literature

Non-Patent Literature 1: “Improvement of visualization method of density gradient based on Background Oriented Schlieren method”, Azuka Pure Chemical, et al., Japan Society of Mechanical Engineers (B), p. 77, 784, December 2011

### SUMMARY OF INVENTION

However, in general, a camera is not provided with the light blocking unit as described above, and it is difficult to visualize the density gradient of the airflow by the method disclosed in Patent Literature 1 in a general-purpose camera or an existing camera.

The present disclosure has been made in view of such problems in the related art. An object of the present disclosure is to provide a fluid density gradient detection method and a fluid density gradient detection system that visualize a density gradient of an airflow with high sensitivity in a general-purpose camera or an existing camera.

The present disclosure provides a fluid density gradient detection method, including: capturing, by an imaging device under a predetermined imaging condition, a background image that forms a periodic pattern over an observation target area; and outputting an image indicating a fluid density gradient in the observation target area based on a captured image captured by the imaging device. The imaging condition is determined based on a relationship between a width of a pixel of the captured image in a direction in which the pattern periodically changes on the captured image and a pattern period width of the pattern on the captured image.

Further, the present disclosure provides a fluid density gradient detection system including: an imaging unit configured to image, under a predetermined imaging condition, a background image forming a periodic pattern over an observation target area; and an image output unit configured to output an image indicating a fluid density gradient in the observation target area based on the captured image captured by the imaging unit. The imaging condition is determined based on a relationship between a width of a pixel of the captured image in a direction in which the pattern periodically changes on the captured image and a pattern period width of the pattern on the captured image.

According to the present disclosure, detection sensitivity of density gradient can be improved.

### BRIEF DESCRIPTION OF DRAWINGS

FIG. 1 is a diagram showing a configuration of an imaging system according to a first embodiment.

FIG. 2A is a diagram showing a schematic configuration of a camera according to the first embodiment, and FIG. 2B is a diagram showing a front surface of an image sensor according to the first embodiment.

FIG. 3 is a diagram showing an example of a pattern forming a background.

FIG. 4 is a diagram showing an example of a captured image in which the pattern of the background is captured by a camera set to a predetermined imaging condition.

FIG. 5A, FIG. 5B, FIG. 5C, FIG. 5D, and FIG. 5E are diagrams showing a relationship between a ratio of IP_{H} to S_{H} and a stripe pattern.

FIG. 6 is a diagram showing an adjustment procedure of an optical unit of the camera.

FIG. 7 is a diagram showing a method of adjusting a zoom position.

FIG. 8A, FIG. 8B, and FIG. 8C are diagrams showing a method of measuring a period P_{M} of moire (interference fringe).

FIG. 9 is a diagram showing a displacement enlargement effect due to moire when the stripe pattern is moved in a range of 1 IP_{H} under a condition of IP_{H}=2.02S_{H}.

FIG. 10 is a diagram showing a configuration of an imaging system according to a second embodiment.

FIG. 11 is a diagram showing an adjustment procedure of a period P_{H} of a stripe pattern.

FIG. 12A and FIG. 12B are diagrams showing rotation of the stripe pattern.

FIG. 13 is a diagram showing the stripe pattern in which a direction is changed for each section.

FIG. 14 is a block diagram showing a schematic configuration of a camera control unit.

### DESCRIPTION OF EMBODIMENTS

(Knowledge that is the Basis of Fluid Density Gradient Detection According to the Present Disclosure)

Moire (interference fringe) is a stripe pattern generated by optical interference between periodic patterns when the periodic patterns are superimposed. For example, when the periodic pattern is projected onto an image sensor of a digital camera which is an aggregate of periodic pixels, moire may be generated. The moire generated by interference with the image sensor specific to the digital camera may be regarded as a problem in comparison with a film camera, and imaging may be performed by shifting a focus or attaching a low-pass filter in order to prevent generation of the moire.

However, in the present disclosure, by actively generating moire due to interference with the image sensor, a displacement enlargement effect of the moire is utilized to realize the visualization of a minute density change which is difficult to perform by the general BOS method.

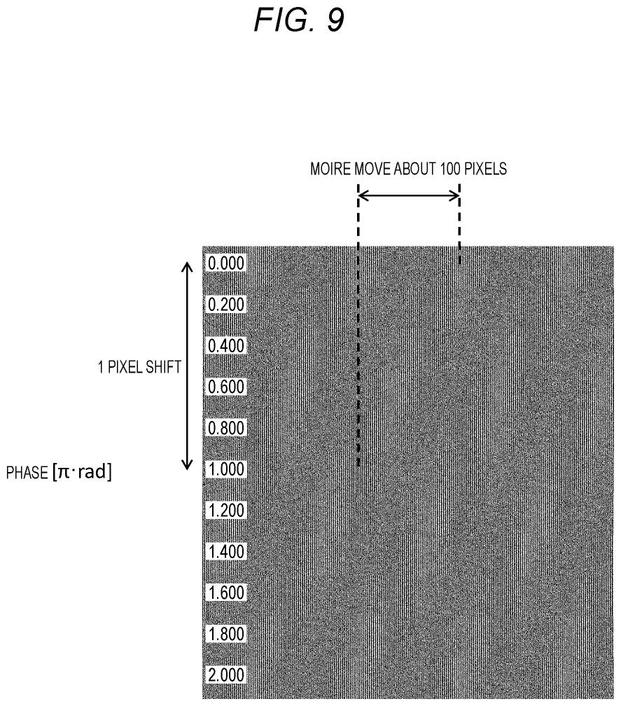

Moire has a characteristic that a small relative displacement between patterns is largely enlarged as a movement amount of the Moire. For example, FIG. 9 is a diagram showing a displacement enlargement effect by the moire when the stripe pattern is moved in the range of 1IP_{H} under the condition of IP_{H}=2.02S_{H}. In FIG. 9, images of moire for each phase displacement (11 patterns of 0 π·rad to 2 π·rad) of the stripe pattern are arranged in a vertical direction with a width of 400 pixels, and the moire appears as a displacement of about 100 pixels in a lateral direction with respect to the displacement of 1 π·rad (=1 pixel) in the vertical direction. In this way, by using the moire, it is possible to enlarge a minute displacement.

In the following embodiments, an example will be described in which high precision visualization of a density gradient by a general-purpose camera is implemented without using special optical equipment by using moire due to interference with an image sensor.

Hereinafter, embodiments specifically disclosing a fluid density gradient detection method and a fluid density gradient detection system according to the present disclosure will be described in detail with reference to the drawings as appropriate. Unnecessarily detailed description may be omitted. For example, a detailed description of a well-known matter or a repeated description of substantially the same configuration may be omitted. This is to avoid unnecessary redundancy in the following description and to facilitate understanding of those skilled in the art. The accompanying drawings and the following description are provided for a thorough understanding of the present disclosure for those skilled in the art, and are not intended to limit the subject matter in the claims.

### First Embodiment

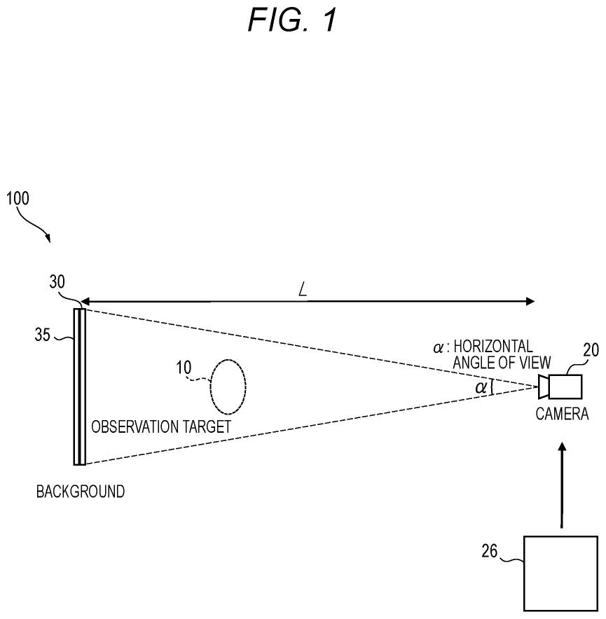

FIG. 1 is a diagram showing a configuration of an imaging system 100 according to a first embodiment. The imaging system 100 includes a camera 20 and a background 30, and observes a density gradient of an observation target 10 by a BOS method. The camera 20 focuses on the background 30 disposed at a distance L, and captures a part or all of the observation target 10 and the background 30 at an angle of view α. The observation target 10 is located in an observation target area between the camera 20 and the background 30, and corresponds to a region including at least a gas such as air.

In the present embodiment, the observation target 10 is assumed to be a gas such as air in which an airflow is generated and which has a density gradient, but may be a liquid, a solid, or the like through which light having a wavelength that can be captured by the camera 20 can be transmitted.

The imaging system 100 may further include a display medium 35 for installing or displaying the background 30. That is, the display medium 35 may be provided on a back side of the background 30 as viewed from the camera 20. The display medium 35 may be configured by a part of a facility such as, for example, a wall. In this case, the background 30 may be formed as a pattern of the wall or the like, or may be projected onto the wall or the like by a projector. Alternatively, the display medium 35 may be a portable medium such as paper or plastic. In this case, the background 30 is printed on the portable medium and attached to the wall, a screen, or the like in the facility. Alternatively, the display medium 35 may be configured by, for example, a display. In this case, the background 30 is displayed on the display.

The imaging system 100 may further include a computer (hereinafter referred to as a “camera control unit 26”) that transmits a control signal for controlling an operation of the camera 20. The control signal includes, for example, a signal for changing optical conditions such as focus and zoom of the camera 20, and a signal for controlling start or stop of imaging. If the camera 20 can pan or tilt, the camera control unit 26 may transmit a control signal for controlling the pan or tilt to the camera 20.

The camera control unit 26 may be integrally incorporated in the camera 20. All or a part of the control of the camera 20 may be executed by a user directly operating an input unit (a button, a lens, a touch panel, or the like) attached to the camera 20 instead of the camera control unit 26.

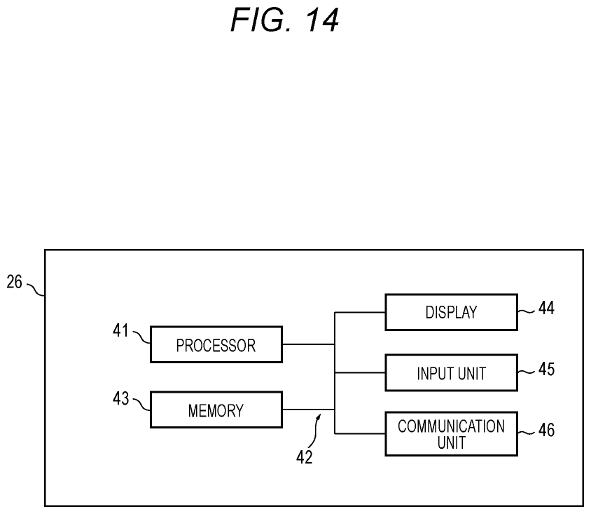

FIG. 14 is a block diagram showing a schematic configuration of the camera control unit 26. As shown in FIG. 14, the camera control unit 26 includes a processor 41, a bus 42, a memory 43, a display 44, an input unit 45, and a communication unit 46. The processor 41, the memory 43, the display 44, the input unit 45, and the communication unit 46 are connected to one another via the bus 42 so that data can be input and output to and from one another.

The processor 41 controls each element of the camera control unit 26 via the bus 42. The processor 41 is configured by using, for example, a general-purpose central processing unit (CPU), and a digital signal processor (DSP), or a field programmable gate array (FPGA). The processor 41 may execute a predetermined program stored in the memory 43 to generate a focus adjustment signal or a zoom adjustment signal based on a captured image captured by the camera 20 or to visualize the density gradient by processing to be described later using the captured image captured by the camera 20.

The memory 43 acquires various kinds of information from other elements, and temporarily or permanently holds the information. The memory 43 is a generic term for a so-called primary storage device and a secondary storage device. A plurality of memories 43 may be physically disposed. As the memory 43, for example, a dynamic random access memory (DRAM), a hard disk drive (HDD), or a solid state drive (SSD) is used.

The display 44 is configured by using, for example, a liquid crystal display (LCD) or an organic electroluminescence (EL) device, and may display a captured image sent from the camera 20 or a result of visualization processing of the density gradient.

The input unit 45 is configured by using an operation device for receiving an operation from the user, and may be, for example, a mouse or a keyboard. The input unit 45 may constitute a touch panel integrated with the display 44.

The communication unit 46 is configured by using a communication circuit for functioning as a communication interface with the camera 20, and, for example, outputs the focus adjustment signal or the zoom adjustment signal to the camera 20 or receives a captured image from the camera 20. In addition, the communication unit 46 may transfer the captured image and the result of the visualization processing of the density gradient to another external device via a network such as the Internet.

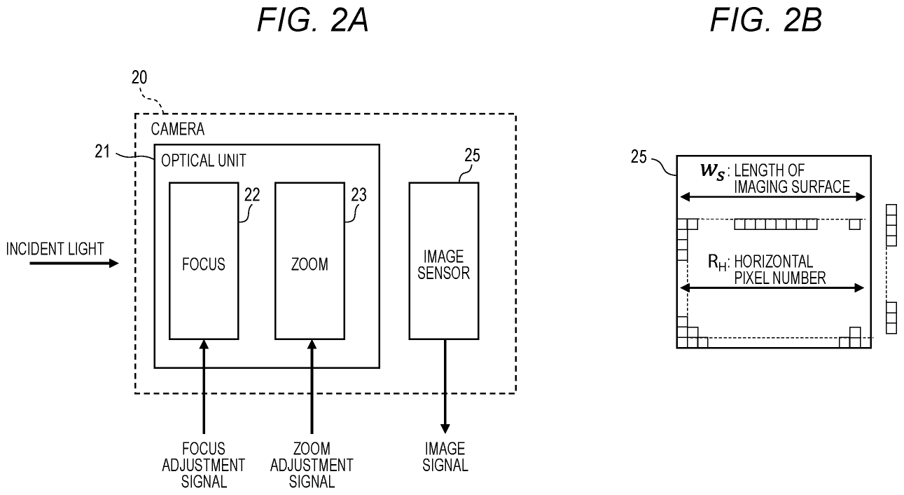

FIG. 2A is a diagram showing a cross section of a schematic configuration of the camera 20 according to the first embodiment. FIG. 2B is a diagram showing a front surface of an image sensor according to the first embodiment. As shown in FIGS. 2A and 2B, the camera 20 (corresponding to an “imaging device”) includes an optical unit 21 and an image sensor 25, and can adjust light incident on the image sensor 25 by operating or controlling the optical unit 21. As will be described in detail later, the camera 20 can image the density gradient of the airflow in the observation target 10 under an appropriate condition by adjusting an optical condition for imaging the observation target 10 and the background 30 by the optical unit 21.

The optical unit 21 includes, for example, a plurality of lenses, includes a focus function unit 22 and a zoom function unit 23, and changes the optical condition of the camera 20. By adjusting a position or the like of one or more lenses constituting the optical unit 21, the focus function unit 22 for adjusting a focus position and the zoom function unit 23 for adjusting a magnitude of the angle of view by zooming are implemented. The optical unit 21 may execute the focus function unit 22 and the zoom function unit 23 by a direct operation by the user or by the focus adjustment signal and the zoom adjustment signal from the camera control unit 26 to be described later.

The image sensor 25 is an aggregate of a plurality of pixels disposed two-dimensionally, and has R_{H} pixels in a length W_{S} of an imaging surface with respect to a direction in which the density change is desired to be visualized. That is, in the image sensor 25 of the camera 20 according to the present embodiment, a total of R_{H} pixels are arranged in a horizontal direction. The image sensor 25 obtains an image signal or image data as an output obtained by imaging, but may image visible light incident on the imaging surface or may image invisible light such as infrared light incident on the imaging surface.

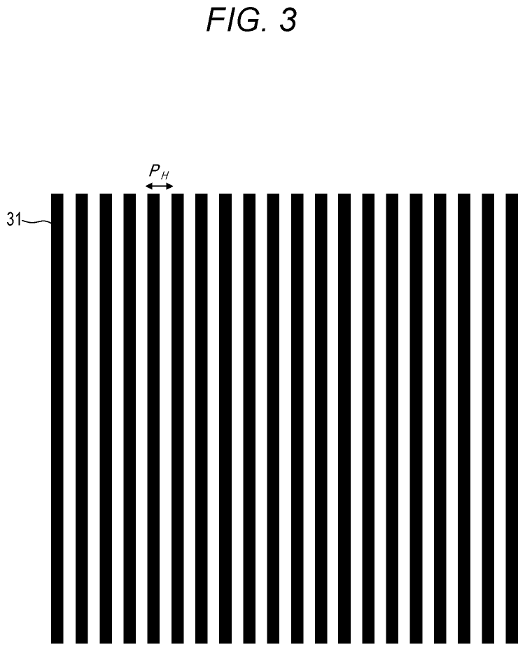

FIG. 3 is a diagram showing an example of a pattern forming the background. The background 30 forms a stripe pattern 31 which is a pattern. The stripe pattern 31 forms a pattern in which a bright portion (white) and a dark portion (black) are repeated in the lateral direction at a period P_{H}. That is, the direction in which the stripe pattern 31 shown in FIG. 3 periodically changes is a lateral direction. The stripe pattern 31 preferably has a distribution in the direction of the density gradient to be visualized, and is suitable for observing the density gradient in the lateral direction (that is, a left-right direction) in the direction of the stripe shown in FIG. 3, for example.

In the present embodiment, the stripe pattern 31 is a monochrome binary stripe pattern, but may be a color stripe pattern, a stripe pattern due to a gradation change, or a lattice pattern.

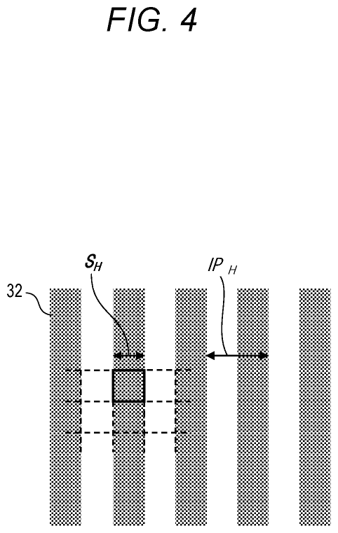

FIG. 4 is a diagram showing an example of a captured image in which the pattern of the background is captured by the camera 20 set to a predetermined imaging condition. A captured image 32 is an aggregate of pixels. In FIG. 4, IP_{H} and S_{H} represent a period (pattern period) of the stripe of the stripe pattern 31 captured as a background image and a width of the pixel in a pattern period direction, respectively. The imaging condition is determined based on a relationship between a pixel width (S_{H}), which is a width of a pixel of the captured image 32 in a direction in which the stripe pattern 31 periodically changes on the captured image 32, and a pattern period width (IP_{H}) of the stripe pattern 31 on the captured image 32. That is, the imaging condition can be adjusted by changing an optical condition (for example, the angle of view (zoom), or the focus) of the camera 20, the distance L (see FIG. 1) between the camera 20 and the background 30, the pattern period width (IP_{H}) of the stripe pattern 31, or the like.

In the present embodiment, in the captured image 32 shown in FIG. 4, the optical unit 21 of the camera 20 is adjusted by the camera control unit 26 such that the relationship between the period IP_{H} of the stripes of the background image shown in the captured image 32 and the pixel width S_{H} of the image is IP_{H}≈2S_{H}. Specifically, in a situation in which the background 30 is separated by the distance L, the background 30 is adjusted to be focused, and the angle of view α of the camera 20 is adjusted by the camera control unit 26 so as to satisfy the above-described relationship (that is, IP_{H}≈2S_{H}). Then, the BOS method is performed using the captured image 32 captured under the conditions.

Under the imaging condition described above, a displacement enlargement effect due to moire appears in the captured image 32 obtained by capturing the observation target 10 and the background image by the camera 20. Accordingly, it is possible to enlarge a displacement less than one pixel generated by a density change gradient of an imaging target (in other words, the observation target 10), and it is possible to improve the detection sensitivity of the density gradient of the BOS method.

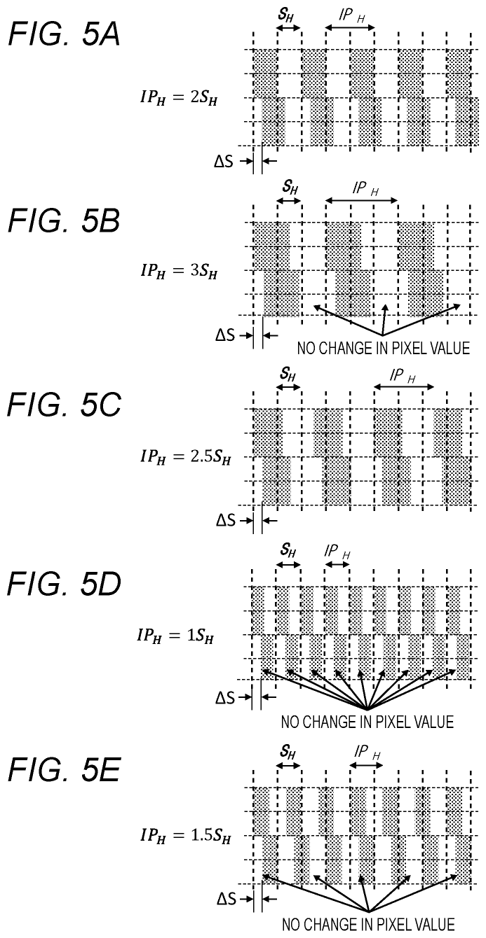

The reason why IP_{H}=2S_{H} is selected as the optical condition will be described with reference to FIGS. 5A to 5E. FIGS. 5A to 5E are diagrams showing a relationship between a ratio of IP_{H} and 2S_{H} and the stripe pattern.

FIG. 5A is a diagram showing a relationship between pixels and the stripe pattern under the condition of IP_{H}=2S_{H}. As compared with a background corresponding to the pixels of upper two stages, a background of lower two stages moves (hereinafter, referred to as a shift ΔS) smaller than the pixel width (S_{H}) which is a width of one pixel in the lateral direction. The shift ΔS is generated by refraction of light by, for example, air having the density gradient of the observation target 10 (that is, the observation target 10).

Then, in the pixels of the lower two stages due to the shift ΔS, a ratio of the bright portion (white) and the dark portion (black) of the stripe pattern in the pixels changes as compared with the pixels of the upper two stages, and thus values of the pixels constituting the image captured by the image sensor 25 change. When the change of the pixel appears as moire, movement of the background (that is, the refraction of the light due to the density gradient of the gas) can be visualized.

For example, when the optical condition (for example, the period I_{PH}) is larger than 2S_{H}, in a state of I_{PH}=3S_{H} shown in FIG. 5B, even if the shift ΔS occurs, the value of the pixel does not change at portions (arrow portions in FIG. 5B) where the ratio of black and white of vertical lines in the pixel does not change.

Here, when the I_{PH} is brought close to 2S_{H} to be in a state of I_{PH}=2.5S_{H} shown in FIG. 5C, the ratio of black and white of the vertical lines in all the pixels changes with respect to the shift ΔS, so that the density gradient of the gas can be detected. However, as compared with FIG. 5A in which each pixel value changes from black and white to an intermediate color (gray) of black and white due to the shift ΔS, in FIG. 5C, since the pixels of gray are always included regardless of the shift ΔS, visibility of the moire is inferior.

Even when the optical condition (for example, the period I_{PH}) is smaller than 2S_{H}, the shift ΔS can be visualized as the I_{PH} approaches 2S_{H}.

For example, in a state of I_{PH}=1 S_{H} shown in FIG. 5D, since the values do not change in all the pixels of the lower two stages in which the shift ΔS is generated, moire does not occur.

Here, when the I_{PH} is brought close to 2S_{H} to be in a state of I_{PH}=1.5S_{H} shown in FIG. 5E, although portions (arrow portions in the drawing) in which the ratio of black and white of the vertical line in the pixel does not change remains with respect to the shift ΔS, moire occurs.

As described above, in the relationship between I_{PH} and 2S_{H}, in the range where I_{PH} is larger than 1.5S_{H} and smaller than 2.5S_{H}, the density gradient of the gas can be clearly visualized by moire particularly under the condition of I_{PH}=2S_{H}.

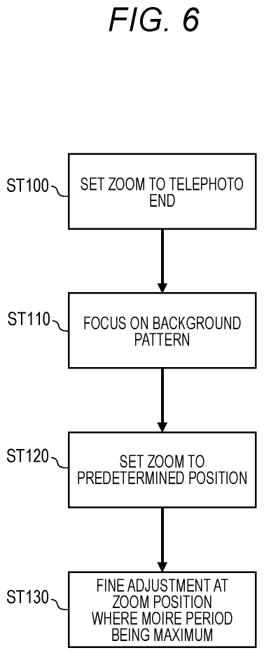

Next, an adjustment procedure of the angle of view α of the camera 20 will be described with reference to FIG. 6. FIG. 6 is a diagram showing an example of an adjustment procedure of the optical unit 21 of the camera 20. In the following description, an example in which the optical unit 21 of the camera 20 is adjusted by the camera control unit 26 will be described, whereas a part or all of each adjustment step may be performed by the direct operation of the user.

First, the camera control unit 26 sets a zoom to a telephoto end using the zoom function unit 23 of the camera 20, and images the stripe pattern 31 of the background 30 in an enlarged manner (ST100).

Next, the camera control unit 26 adjusts the focus on the background 30 using the focus function unit 22 (ST110). The focus adjustment may be performed by a general autofocus function.

Next, the camera control unit 26 performs rough adjustment (an example of a first adjustment) of the angle of view α by the zoom function unit 23 (ST120). An adjustment target value of the angle of view α is calculated from the following (Formula 1) using the distance L from the camera 20 to the background 30, the horizontal pixel number R_{H} of the image sensor 25, and the period P_{H} of the stripe pattern 31 of the background 30 (see FIGS. 1, 2, and 3).

$$1.5 \times \frac{2 L}{{R}_{H}} tan \frac{α}{2} < {P}_{H} < 2.5 \times \frac{2 L}{{R}_{H}} tan \frac{α}{2} \qquad [ Formula 1 ]$$

When a focus length f is used as a unit of zoom adjustment, a relationship between the angle of view α and the focus length f can be obtained using the following (Formula 2). W_{S} is a length of an effective region of the imaging surface of the image sensor 25 (see FIGS. 2A and 2B).

$$α = 2 {tan}^{- 1} \frac{{w}_{s}}{2 f} \qquad [ Formula 2 ]$$

In the captured image 32 captured by focusing on the background 30 under the optical condition of (Formula 1), the relationship between the period I_{PH} of the stripe pattern 31 and the pixel width S_{H} of the image is 1.5S_{H}<I_{PH}<2.5S_{H}, and moire occurs due to interference between a pixel row of the image sensor 25 and the stripe pattern 31.

When the image sensor 25 is an image sensor that generates a grayscale image, since one pixel on the image sensor corresponds to one pixel of generated grayscale image data, the horizontal pixel number R_{H} corresponds to the horizontal pixel number on the image sensor 25. On the other hand, when the image sensor 25 is configured by a Bayer array and generates a color image, since one set of arrays corresponds to one pixel in image data, the horizontal pixel number R_{H} corresponds to the number of sets of arrays.

After the rough adjustment (an example of the first adjustment) of the angle of view α in step ST120, the camera control unit 26 performs fine adjustment (an example of second adjustment) of the zoom position (focus length f) using moire (ST130).

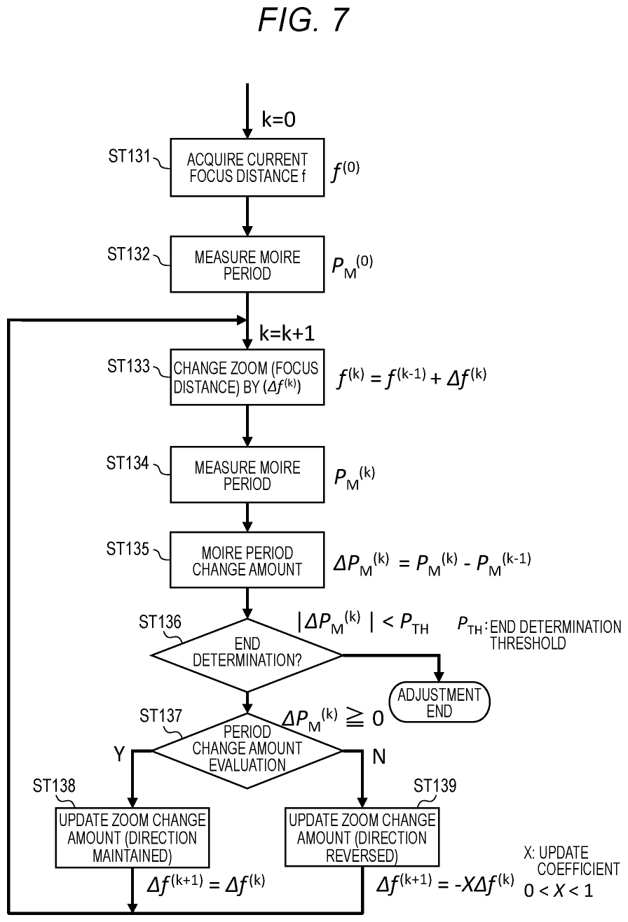

Here, the fine adjustment of the zoom position of the camera will be described in detail with reference to FIG. 7. FIG. 7 is a diagram showing a method of adjusting the zoom position using a period P_{M} of the moire (interference fringe). In the following description, although an example in which the optical unit 21 of the camera 20 is adjusted by the camera control unit 26 will be described, a part or all of each adjustment step may be performed by the direct operation of the user.

In step ST131, the camera control unit 26 stores the focus length corresponding to the angle of view adjusted in step ST120 as a focus length f⁽⁰⁾ when the number of repetitions k=0.

In step ST132, the camera control unit 26 measures a moire period P_{M}⁽⁰⁾ by a method described later.

In step ST133, the camera control unit 26 changes the zoom position so that the focus length f is shifted by Δf^{(K)}.

In step ST134, the camera control unit 26 measures the moire period P_{M}^{(K)} after the zoom position is changed.

In step ST135, the camera control unit 26 calculates a difference ΔP_{M}^{(K)} between P_{M}^{(K)} and P_{M}^{(K-1)} before the zoom change.

In step ST136, the camera control unit 26 compares an absolute value of ΔP_{M}^{(K)} with an end determination threshold P_{TH}. The end determination threshold P_{TH} is set to a value at which a change in ΔP_{M}^{(K)} is reduced to such an extent that the change cannot be visually determined, for example.

When ΔP_{M}^{(K)} is larger than P_{TH}, the processing proceeds to the next step. When ΔP_{M}^{(K)} is smaller than P_{TH}, the processing is completed assuming that the adjustment is completed.

A processing completion condition may include not only the comparison between ΔP_{M}^{(K)} and P_{TH}, but also a condition to end when a loop counter k exceeds a predetermined value. Accordingly, even when the zoom adjustment is performed, it is possible to end the processing even when the zoom adjustment does not converge to the end determination threshold P_{TH} or less.

In step ST137, the camera control unit 26 determines whether ΔP_{M}^{(K)} is equal to or greater than 0. When ΔP_{M}^{(K)} is 0 or more, the processing proceeds to step ST137. When ΔP_{M}^{(K)} is smaller than 0, the processing proceeds to step ST138.

In step ST138, a next zoom adjustment width Δf^{(K+1)} is set to be equal to Δf^{(K)}, and the processing returns to step ST133.

In step ST139, the camera control unit 26 sets the next zoom adjustment width Δf^{(K+1)} to −XΔf^{(k)}, and the processing returns to step ST133. X is an update coefficient that satisfies 0<X<1.

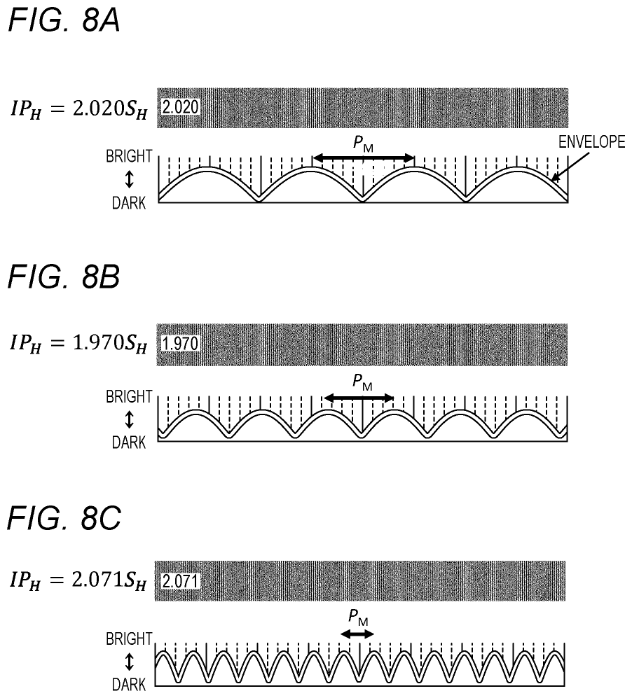

Here, a method of measuring the period P_{M} of the moire (interference fringe) will be described. FIGS. 8A to 8C are diagrams showing the method of measuring the period P_{M} of the moire (interference fringe). FIG. 8A shows a moire pattern (upper part) when I_{PH}=2.020S_{H} and a graph of shading of the moire pattern (lower part). Here, an envelope is drawn with respect to the moire pattern, and a period of the envelope is measured, so that the period P_{M} of the moire can be measured. The period P_{M} of the moire is the longest when I_{PH}=2S_{H}, and the period is shorter than that of FIG. 8A in the case of I_{PH}=1.970S_{H} shown in FIG. 8B or in the case of I_{PH}=2.071S_{H} shown in FIG. 8C.

According to the above procedure, the optical unit 21 of the camera 20 can be adjusted such that the relationship between the stripe period I_{PH} of the captured image 32 and the pixel width S_{H} of the image is I_{PH}≈2S_{H}.

Next, a method of visualizing the density gradient of the observation target 10 using the captured image 32 captured under the above-described optical conditions will be described.

The density gradient of the airflow is visualized by performing image processing using a reference background image captured using a camera in a state where the density gradient of the airflow is not generated in the observation target area and an observation background image captured in a state where the density gradient of the airflow is generated in the observation target area.

The image processing is performed by the camera control unit 26, and for example, a method described in Patent Literature 2 may be used.

Alternatively, the background image for observation may be continuously acquired without using a difference between the reference background image and the observation background image, and a frame difference between the latest background image and the background image captured a unit time before (one frame before) the latest background image may be used.

By using the frame difference, it is possible to prevent the influence when the position of the camera is shifted between a time of capturing the reference image and a time of capturing the observation image and the optical condition is changed.

### Second Embodiment

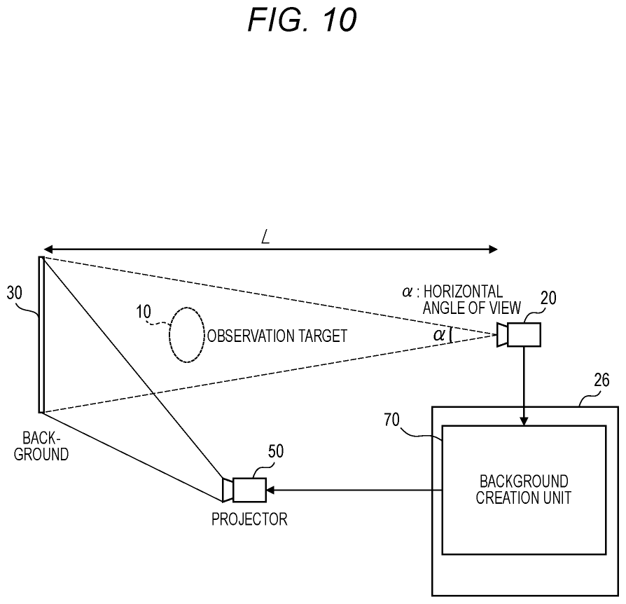

Next, a second embodiment will be described. Members described in the first embodiment are denoted by the same reference numerals, and detailed description thereof will be omitted. In the first embodiment, the stripe pattern 31 is fixed on the background 30. The second embodiment is an imaging system projected by a projector 50 on the background 30 as shown in FIG. 10. FIG. 10 is a diagram showing a configuration of the imaging system according to the second embodiment. Although the projection is performed by the projector in the present embodiment, the background may be a display device and the stripe pattern 31 may be projected as an image.

The projector 50 projects an image input from the camera control unit 26.

The camera control unit 26 includes a background creation unit 70 that is connected to the camera 20, analyzes the background image captured by the camera 20, and changes the period P_{H} of the stripe pattern 31 projected onto the display medium 35 such as a screen or a wall by the projector 50. The background creation unit 70 is implemented by a processor 41 (see FIG. 14).

In the second embodiment, a single focus camera can be used as the camera 20. In the first embodiment, a camera having an optical zoom function is used. However, in general, there is also a single focus camera without the optical zoom function.

When the single focus camera without the optical zoom function is used to approach IP_{H}=2S_{H}, it is necessary to change the distance L because the angle of view α cannot be adjusted in the first embodiment. However, when installation places of the camera 20 and the display medium 35 are restricted, it is difficult to change the distance L.

In the second embodiment, even if the angle of view α of the camera 20 is fixed, or even if the installation places of the camera 20 and the display medium 35 are restricted, the imaging condition of I_{PH}≈2S_{H} can be adjusted by changing the period P_{H} that can be said to be an interval of the stripes of the stripe pattern 31 of the background 30.

Hereinafter, a method of generating the background 30 in the background creation unit 70 will be described. In order to adjust the imaging condition by changing the background 30, first, the background creation unit 70 creates a stripe pattern of the background so as to satisfy the above-described (Formula 1) as an initial value P_{H}⁽⁰⁾ of the stripe pattern (an example of the first adjustment).

Here, the distance L between the camera 20 and the background in (Formula 1) may be actually measured and input, or the background creation unit 70 may input a figure of a known size to the projector 50, measure the size of the figure from the image captured by the camera 20, and estimate the distance L from the size.

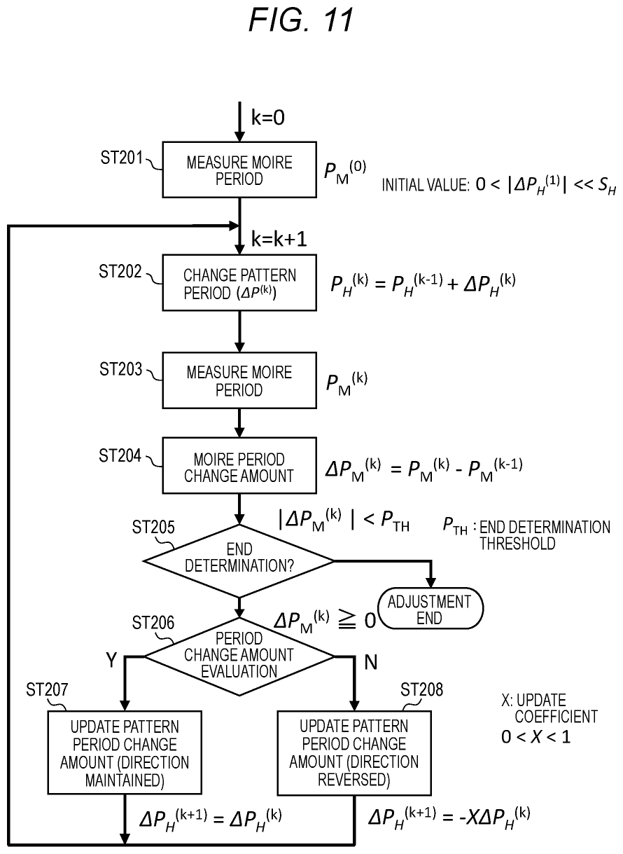

Next, according to FIG. 11, the period P_{H} of the stripe pattern 31 is adjusted (an example of the second adjustment). FIG. 11 is a diagram showing an adjustment procedure of the period P_{H} of the stripe pattern.

In step ST201, the background creation unit 70 measures a moire period P_{M}⁽⁰⁾.

In step ST202, the background creation unit 70 changes the period P_{H} of the stripe pattern 31 by an adjustment width ΔP_{H}^{(k)} of the stripe pattern.

In step ST203, the background creation unit 70 measures a moire period P_{M}^{(k)}.

In step ST204, the background creation unit 70 calculates a difference ΔP_{M}^{(k)} between the P_{M}^{(k)} and P_{M}^{(k-1)} before the stripe pattern is changed.

In step ST205, the background creation unit 70 compares an absolute value of ΔP_{M}^{(k)} with the end determination threshold P_{TH}. When |ΔP_{M}^{(k)}| is equal to or greater than P_{TH}, the processing proceeds to the next step. When |ΔP_{M}^{(k)}| is smaller than the threshold, the processing is completed assuming that the adjustment of the period P_{H} of the stripe pattern 31 is completed. The end determination threshold P_{TH} is set to a value at which a change in ΔP_{TH}^{(K)} is reduced to such an extent that the change cannot be visually determined, for example.

In step ST206, the background creation unit 70 determines whether ΔP_{M}^{(K)} is equal to or greater than 0. When ΔP_{M}^{(K)} is 0 or more, the processing proceeds to step ST207. When ΔP_{M}^{(K)} is smaller than 0, the processing proceeds to step ST208. In step ST207, the background creation unit 70 sets the adjustment width ΔP_{H}^{(K+1)} of the next stripe pattern to be equal to ΔP_{H}^{(K)}, and the processing returns to step ST202.

In step ST208, the background creation unit 70 changes the adjustment width ΔP_{H}^{(K+1)} of the next stripe pattern to −XΔP_{H}^{(K)}, and the processing returns to step ST202. X is an update coefficient that satisfies 0<X<1.

According to the above procedure, the stripe pattern 31 of the background 30 can be adjusted such that the relationship between the stripe period I_{PH} of the captured image 32 and the pixel width S_{H} of the image is IP_{H}≈2S_{H}.

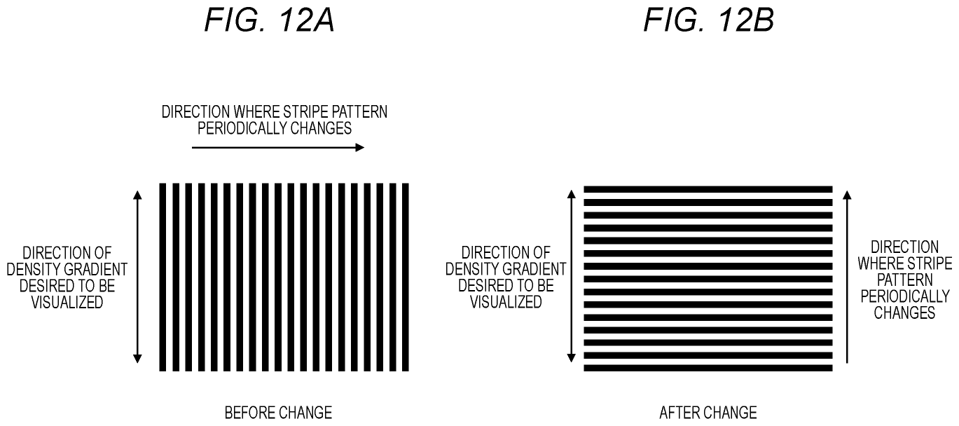

The background creation unit 70 may rotate the stripe pattern 31 of the background 30 so that the stripe pattern 31 is distributed in the direction of the density gradient desired to be visualized. FIGS. 12A and 12B are diagrams showing rotation of the stripe pattern. For example, as in the background 30 before change (before rotation) shown in FIG. 12A, when the direction in which the user desires to visualize the density gradient and the direction in which the stripe pattern 31 periodically changes do not coincide with each other, the background creation unit 70 can cause the stripe pattern 31 to coincide with each other by rotating (changing) the stripe pattern 31 as shown in FIG. 12B. Accordingly, even when the direction of the density gradient of a measurement target changes, sensitivity of the BOS method can be improved. The rotation of the stripe pattern 31 is performed according to the user in the direction of the density gradient to be visualized.

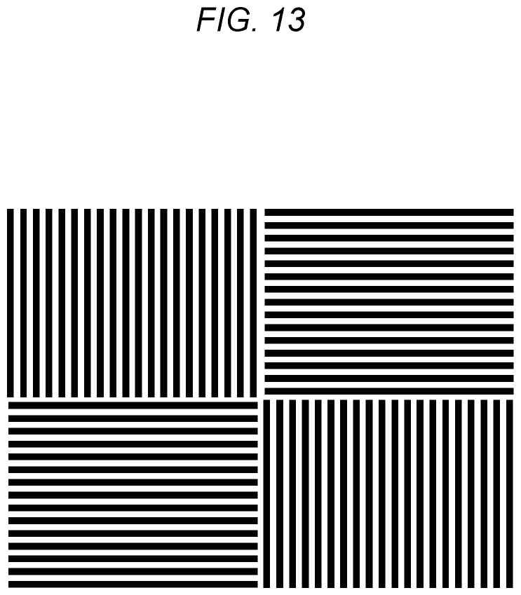

As shown in FIG. 13, the background creation unit 70 may divide the background 30 into sections and change the direction of the stripes of the stripe pattern 31 for each section according to the direction of the density change gradient. FIG. 13 is a diagram showing a stripe pattern in which the direction is changed for each section. Accordingly, even when the direction of the density change is not uniform, the sensitivity of the BOS method can be improved.

Further, when the displacement due to the density change is large, the stripe pattern 31 of the background 30 may be changed, and the method may be switched to the BOS method in which the effect of enlarging the moire is not used. As the stripe pattern 31 in this case, for example, the stripe pattern described in Non-Patent Literature 1 may be used.

According to the method, when atmospheric pressure density change is large, measurement can be performed by a general BOS method, and a range of the measurable density change can be enlarged.

A fluid density gradient detection method according to an aspect of the present disclosure is a method of visualizing a density gradient of an observation target area using a background image in which a stripe pattern is present as a background of the observation target area and the background is captured over the observation target area. A background image captured under an optical condition in which a period of stripes of a stripe pattern in the background image falls within a range of 150% to 250% of a width of one pixel.

A fluid density gradient detection method according to an aspect of the present disclosure includes: capturing, by an imaging device under a predetermined imaging condition, a background image that forms a periodic pattern over an observation target area; and outputting an image indicating a fluid density gradient in the observation target area based on a captured image captured by the imaging device. The imaging condition is determined based on a relationship between a width (S_{H}) of a pixel of the captured image in a direction in which the pattern periodically changes on the captured image and a pattern period width (I_{PH}) of the pattern on the captured image. Accordingly, since the observation target area is captured under the imaging condition in which the width of the pixel of the captured image and the pattern period width have an appropriate relationship, it is possible to improve the detection sensitivity of the fluid density gradient without using a special optical system.

A fluid density gradient detection method according to an aspect of the present disclosure includes: capturing, by an imaging device under a predetermined imaging condition, a background image that forms a periodic pattern over an observation target area; and outputting an image indicating a fluid density gradient in the observation target area based on a captured image captured by the imaging device. In the imaging condition, a relationship between a width (S_{H}) of a pixel of the captured image in a direction in which the pattern periodically changes on the captured image and a pattern period width (I_{PH}) of the pattern on the captured image is determined such that the pattern period width (I_{PH}) is in a range of 150% to 250% with respect to the width (S_{H}) of the pixel. Accordingly, it is possible to enlarge a change of less than one pixel of the captured image, and it is possible to improve the detection sensitivity of the fluid density gradient without using a special optical system.

A fluid density gradient detection method according to another aspect of the present disclosure includes: capturing, by an imaging device under a predetermined imaging condition, a background image that forms a periodic pattern over an observation target area; and outputting an image indicating a fluid density gradient in the observation target area based on a captured image captured by the imaging device. The imaging condition is determined based on a relationship between a width (S_{H}) of a pixel of the captured image in a direction in which the pattern on the captured image periodically changes and a pattern period width (I_{PH}) of the pattern on the captured image and a period of moire generated on the captured image. Accordingly, since the observation target area is captured under the appropriate imaging condition in which the relationship between the width of the pixel of the captured image and the pattern period width is determined by the period of the moire generated in the captured image, it is possible to improve the detection sensitivity of the fluid density gradient without using a special optical system.

A fluid density gradient detection method according to an aspect of the present disclosure includes: capturing, by an imaging device under a predetermined imaging condition, a background image that forms a periodic pattern over an observation target area; and outputting an image indicating a fluid density gradient in the observation target area based on a captured image captured by the imaging device. The imaging condition performs a first adjustment based on a relationship between a width (S_{H}) of a pixel of the captured image in a direction in which the pattern periodically changes on the captured image and a pattern period width (I_{PH}) of the pattern on the captured image, and further performs a second adjustment based on a period of moire generated on the captured image captured under the imaging condition adjusted by the first adjustment. Accordingly, first, moire is generated in the captured image, the width of the pixel of the captured image and the pattern period width are adjusted to an appropriate relationship using the period of the moire generated next, and the observation target area is captured, so that the detection sensitivity of the fluid density gradient can be improved without using a special optical system.

A fluid density gradient detection method according to an aspect of the present disclosure includes: capturing, by an imaging device under a predetermined imaging condition, a background image that forms a periodic pattern over an observation target area; and outputting an image indicating a fluid density gradient in the observation target area based on a captured image captured by the imaging device. The imaging condition performs a first adjustment based on a relationship between a width (S_{H}) of a pixel of the captured image in a direction in which the pattern periodically changes on the captured image and a pattern period width (I_{PH}) of the pattern on the captured image, and further performs a second adjustment based on a period of moire generated on the captured image captured under the imaging condition adjusted by the first adjustment so that the period of the moire becomes the longest. Accordingly, first, moire is generated in the captured image, the width of the pixel of the captured image and the pattern period width are adjusted to an appropriate relationship using the period of the moire generated next, and the observation target area is captured, so that the detection sensitivity of the fluid density gradient can be improved without using a special optical system.

A fluid density gradient detection method according to an aspect of the present disclosure includes: capturing, by an imaging device under a predetermined imaging condition, a background image that forms a periodic pattern over an observation target area; and outputting an image indicating a fluid density gradient in the observation target area based on a captured image captured by the imaging device. The imaging condition is determined based on a relationship between a width (S_{H}) of a pixel of the captured image in a direction in which the pattern periodically changes on the captured image and a pattern period width (I_{PH}) of the pattern on the captured image, and the imaging condition is changed by adjusting an optical condition of the imaging device including an angle of view. Accordingly, since the observation target area is captured under the imaging condition in which the width of the pixel of the captured image and the pattern period width have an appropriate relationship, it is possible to improve the detection sensitivity of the fluid density gradient without using a special optical system.

A fluid density gradient detection method according to an aspect of the present disclosure includes: capturing by an imaging device, under a predetermined imaging condition, a background image that forms a periodic pattern over an observation target area; and outputting an image indicating a fluid density gradient in the observation target area based on a captured image captured by the imaging device. The imaging condition is determined based on a relationship between a width (S_{H}) of a pixel of the captured image in a direction in which the pattern periodically changes on the captured image and a pattern period width (I_{PH}) of the pattern on the captured image, and the imaging condition is changed by adjusting the pattern period width (I_{PH}) of the pattern. Accordingly, since the observation target area is captured under the imaging condition in which the width of the pixel of the captured image and the pattern period width have an appropriate relationship, it is possible to improve the detection sensitivity of the fluid density gradient even in a camera without a zoom function.

A fluid density gradient detection method according to an aspect of the present disclosure includes: capturing, by an imaging device under a predetermined imaging condition, a background image that forms a periodic pattern over an observation target area; and outputting an image indicating a fluid density gradient in the observation target area based on a captured image captured by the imaging device. The imaging condition is determined based on a relationship between a width (S_{H}) of a pixel of the captured image in a direction in which the pattern periodically changes on the captured image and a pattern period width (I_{PH}) of the pattern on the captured image, and the imaging condition is changed by adjusting the pattern period width (I_{PH}) of the pattern. Further, the pattern period width (I_{PH}) is changed in accordance with a magnitude of a gas density gradient in the observation target area. Accordingly, since the observation target area is captured under the imaging condition in which the width of the pixel of the captured image and the pattern period width have an appropriate relationship in accordance with the magnitude of the gas density gradient of the observation target area, it is possible to change the detection sensitivity in accordance with the magnitude of the fluid density gradient without using a special optical system.

A fluid density gradient detection method according to an aspect of the present disclosure includes: capturing by an imaging device, under a predetermined imaging condition, a background image that forms a periodic pattern over an observation target area; and outputting an image indicating a fluid density gradient in the observation target area based on a captured image captured by the imaging device. The imaging condition is determined based on a relationship between a width (S_{H}) of a pixel of the captured image in a direction in which the pattern periodically changes on the captured image and a pattern period width (I_{PH}) of the pattern on the captured image, and further determines a direction in which the pattern periodically changes in accordance with a direction of a gas density gradient in the observation target area. Accordingly, even when the direction of the density gradient of the measurement target changes, the detection sensitivity of the fluid density gradient can be improved by maintaining an appropriate relationship between the width of the pixel of the captured image and the pattern period width.

A fluid density gradient detection method according to an aspect of the present disclosure includes: capturing, by an imaging device under a predetermined imaging condition, a background image that forms a periodic pattern over an observation target area; and outputting an image indicating a fluid density gradient in the observation target area based on a captured image captured by the imaging device. The imaging condition is determined based on a relationship between a width (S_{H}) of a pixel of the captured image in a direction in which the pattern periodically changes on the captured image and a pattern period width (I_{PH}) of the pattern on the captured image. Further, the background image is divided into a plurality of sections, and the direction of the pattern is determined for each section in accordance with a direction of a gas density gradient in the observation target area. Accordingly, even when there are a plurality of directions of the density change of the measurement target in an imaging target area, it is possible to maintain an appropriate relationship between the width of the pixel of the captured image and the pattern period width according to each direction, and it is possible to improve the detection sensitivity of the fluid density gradient.

A fluid density gradient detection method according to an aspect of the present disclosure includes: capturing, by an imaging device under a predetermined imaging condition, a background image that forms a periodic pattern over an observation target area; and outputting an image indicating a fluid density gradient in the observation target area based on a captured image captured by the imaging device. Adjustment of the imaging condition is performed in a state where a focus of the imaging device is adjusted to the background image. First, a first adjustment is performed based on a relationship between a width (S_{H}) of a pixel of the captured image in a direction in which the pattern periodically changes on the captured image and a pattern period width (I_{PH}) of the pattern on the captured image, and further a second adjustment is performed based on a period of moire generated on the captured image captured under the imaging condition adjusted by the first adjustment. Accordingly, since the observation target area is captured under the appropriate imaging condition in which the relationship between the width of the pixel of the captured image and the pattern period width is determined by the period of the moire generated in the captured image, it is possible to improve the detection sensitivity of the fluid density gradient without using a special optical system.

A fluid density gradient detection system according to an aspect of the present disclosure includes: an imaging unit configured to image, under a predetermined imaging condition, a background image forming a periodic pattern over an observation target area; and an image output unit configured to output an image indicating a fluid density gradient in the observation target area based on the captured image captured by the imaging unit. The imaging condition is determined based on a relationship between a width (S_{H}) of a pixel of the captured image in a direction in which the pattern periodically changes on the captured image and a pattern period width (I_{PH}) of the pattern on the captured image. Accordingly, since the observation target area is captured under the imaging condition in which the width of the pixel of the captured image and the pattern period width have an appropriate relationship, it is possible to improve the detection sensitivity of the fluid density gradient without using a special optical system.

A fluid density gradient detection system according to an aspect of the present disclosure includes: an imaging unit configured to image, under a predetermined imaging condition, a background image forming a periodic pattern over an observation target area; an image output unit configured to output an image indicating a fluid density gradient in the observation target area based on the captured image captured by the imaging unit; and a control unit configured to change an optical condition of the imaging unit. The imaging condition is determined based on a relationship between a width (S_{H}) of a pixel of the captured image in a direction in which the pattern periodically changes on the captured image and a pattern period width (I_{PH}) of the pattern on the captured image. The control unit adjusts the optical condition such that a period of moire of the captured image is longest. Accordingly, first, moire is generated in the captured image, the width of the pixel of the captured image and the pattern period width are adjusted to an appropriate relationship using the period of the moire generated next, and the observation target area is captured, so that the detection sensitivity of the fluid density gradient can be improved without using a special optical system.

A fluid density gradient detection system according to an aspect of the present disclosure includes: an imaging unit configured to image, under a predetermined imaging condition, a background image forming a periodic pattern over an observation target area; an image output unit configured to output an image indicating a fluid density gradient in the observation target area based on the captured image captured by the imaging unit; and a background creation unit configured to change the background image. The imaging condition is determined based on a relationship between a width (S_{H}) of a pixel of the captured image in a direction in which the pattern periodically changes on the captured image and a pattern period width (I_{PH}) of the pattern on the captured image. The background creation unit adjusts the background image such that a period of moire of the captured image is longest. Accordingly, first, moire is generated in the captured image, the width of the pixel of the captured image and the pattern period width are adjusted to an appropriate relationship by using the period of the moire generated next, and the observation target area is captured, so that the detection sensitivity of the fluid density gradient can be improved even in a camera without a zoom function.

### INDUSTRIAL APPLICABILITY

The present disclosure can improve detection sensitivity of a method of visualizing a density gradient of an airflow in a general-purpose camera, and is useful for a fluid density gradient detection method and a fluid density gradient detection system that visualize a minute airflow in an indoor space and visualize a temperature change.

What is claimed is:

1. A fluid density gradient detection method comprising:
capturing, by an imaging device under a predetermined imaging condition, a background image that forms a periodic pattern over an observation target area; and
outputting an image indicating a fluid density gradient in the observation target area based on a captured image captured by the imaging device,
wherein the imaging condition is determined based on a relationship between a width of a pixel of the captured image in a direction in which the pattern periodically changes on the captured image and a pattern period width of the pattern on the captured image.

2. The fluid density gradient detection method according to claim 1,
wherein the imaging condition is set such that the pattern period width on the captured image is in a range of 150% to 250% with respect to the width of the pixel.

3. The fluid density gradient detection method according to claim 1,
wherein the imaging condition is further determined based on a period of moire generated on the captured image.

4. The fluid density gradient detection method according to claim 1, further comprising:
performing a first adjustment of adjusting the imaging condition so that the pattern period width on the captured image is within a predetermined range with respect to the width of the pixel; and
performing a second adjustment of further adjusting the imaging condition adjusted by the first adjustment based on the period of moire generated on the captured image captured under the imaging condition.

5. The fluid density gradient detection method according to claim 4,
wherein in the second adjustment, the imaging condition is adjusted such that the period of the moire is longest.

6. The fluid density gradient detection method according to claim 1,
wherein the imaging condition is changed by adjusting an optical condition of the imaging device including an angle of view.

7. The fluid density gradient detection method according to claim 1,
wherein the imaging condition is changed by adjusting a pattern period width of the pattern.

8. The fluid density gradient detection method according to claim 7,
wherein the pattern period width is changed in accordance with a magnitude of a gas density gradient in the observation target area.

9. The fluid density gradient detection method according to claim 1, further comprising:
determining a direction in which the pattern periodically changes in accordance with the direction of the gas density gradient in the observation target area.

10. The fluid density gradient detection method according to claim 9, further comprising:
dividing the background image into a plurality of sections; and
determining, for each of the sections, a direction of the pattern in accordance with the direction of the gas density gradient in the observation target area.

11. The fluid density gradient detection method according to claim 4,
wherein the first adjustment and the second adjustment are performed in a state where a focus of the imaging device is adjusted to the background image.

12. A fluid density gradient detection system comprising:
an imaging unit configured to image, under a predetermined imaging condition, a background image forming a periodic pattern over an observation target area; and
an image output unit configured to output an image indicating a fluid density gradient in the observation target area based on the captured image captured by the imaging unit,
wherein the imaging condition is determined based on a relationship between a width of a pixel of the captured image in a direction in which the pattern periodically changes on the captured image and a pattern period width of the pattern on the captured image.

13. The fluid density gradient detection system according to claim 12, further comprising:
a control unit configured to change an optical condition of the imaging unit,
wherein the control unit adjusts the optical condition so that a period of moire of the captured image is longest.

14. The fluid density gradient detection system according to claim 12, further comprising:
a background creation unit configured to change the background image,
wherein the background creation unit adjusts the background image such that a period of moire of the captured image is longest.
